(19) United States
(12) Patent Application Publication
(10) Pub. No.: US 2006/0227422 A1
(43) Pub. Date: Oct. 12, 2006

(54) Circular polarizer using frequency selective surfaces

(76) Inventors: Brian Monacelli, Orlando, FL (US); Glenn Boreman, Geneva, FL (US)

Correspondence Address: AKERMAN SENTERFITT, P.O. BOX 3188, WEST PALM BEACH, FL, 33402-3188, US

(21) Appl. No.: 11/104,138

(22) Filed: Apr. 12, 2005

(51) Int. Cl. G02B 27/28; G02B 5/30

(52) U.S. Cl. 359/485; 359/352

(57) ABSTRACT

A circular polarizer (CP) includes an electrically insulating or semiconducting and optically transparent layer having a frequency selective surface (FSS) disposed thereon, the FSS includes a periodic array of electrically conductive spirals. For reflection mode operation, an electrically conducting substrate or ground plane layer preferably having a thickness of approximately one-quarter wave at the nominal design wavelength is disposed beneath the optically transparent layer.

### CROSS-REFERENCE TO RELATED APPLICATIONS

Not applicable.

### STATEMENT REGARDING FEDERALLY SPONSORED RESEARCH OR DEVELOPMENT

Not applicable.

### FIELD OF THE INVENTION

The invention relates to circular polarizers, more specifically circular polarizers based on frequency selective surfaces (FSS).

### BACKGROUND

Circular polarizers are polarized wave converters which convert a linearly polarized wave into a circularly polarized wave, or a circularly polarized wave into a linearly polarized wave.

FIGS. 1A, 1B, 1C, 1D schematically show structures of conventional circular polarizers. These circular polarizers 53a, 53b, 53c and 53d, respectively convert a circularly polarized wave into a linearly polarized wave. Their operation mechanism will be briefly described below.

In the case where a circularly polarized wave is to be converted into a linearly polarized wave, it is assumed that the two linearly polarized waves orthogonal to each other constitute the circularly polarized wave and the phases of the two linearly polarized waves are displaced by 90 degrees. A circularly polarized wave Ec is converted into a linearly polarized wave Er by retarding the phase of the linearly polarized wave that is advanced 90 degrees to set the phase difference, to 0 degrees.

For example, a dielectric phase plate 61 in a circular polarizer 53a shown in FIG. 1A is provided to have an angle of approximately 45 degrees with respect to a linearly polarized wave Er that is to be converted. An electric field E₁ parallel to dielectric phase plate 61 passes through dielectric phase plate 61. The phase of one linear polarization component is delayed with respect to the other, when such an optic, called a quarter-wave plate, is oriented as described with respect to the incident wave. As a result, the phase of electric field E₁ is behind the phase of an electric field E₂ orthogonal to dielectric phase plate 61. By setting this phase delay to 90 degrees, the phase difference between electric fields E₁ and E₂ becomes 0 degrees, thereby converting circularly polarized wave Ec into linearly polarized wave Er.

Circular polarizer 53b of FIG. 1B is provided with a plurality of cylindrical metal projections at the waveguide. By retarding the phase of electric field E₁ 90 degrees by the cylindrical metal projection, circularly polarized wave Ec is converted into linearly polarized wave Er. Circular polarizer 53c of FIG. 1C is provided with an arc shape metal bulk within the waveguide. By retarding the phase of electric field E₁ 90 degrees by the metal bulk, circularly polarized wave Ec is converted into linearly polarized wave Er. Circular polarizer 53d of FIG. 1D is provided with plate-like metal projections within the waveguide. By retarding the phase of electric field E₁ 90 degrees by the plate-like metal projection, circularly polarized wave Ec is converted into linearly polarized wave Er.

Conventional circular polarizers are commonly embodied as quarter-wave plates which operate similar to the polarizers shown in FIGS. 1 A-D. As such, a common feature of conventional circular polarizers is the need for large, bulky optical components, and/or the requirement for a large resonant cavity for polarization conditioning. Conventional circular polarizers are also generally formed using costly materials.

The modification of the spectral radiation signature of a surface, in absorption, reflection, or transmission, is possible by patterning the surface with a periodic array of electrically conducting elements, or with a periodic array of apertures in an electrically conducting sheet. Spectral modifications have been readily shown using such structures in the literature for millimeter-wave and infrared radiation and are known as frequency selective surfaces (FSS). Such surfaces have been configured to function as spectral filters, such as low-pass, high-pass, bandpass, or dichroic filters. FSS can even be used as narrowband infrared sources, by virtue of Kirchhoff's Law in which the FSS absorptive properties equal its emissive properties. Other applications include FSS use as a pollutant sensing element, as a reflecting element in an infrared laser cavity and as an infrared source with a unique emission spectrum. However, prior to the invention, FSS were never disclosed for use as polarization filters.

### SUMMARY

A circular polarizer (CP) includes a frequency selective surface (FSS) layer that is disposed on an electrically insulating or semiconducting optically transparent substrate support. The FSS comprises a periodic array of spaced electrically conductive spirals. CPs according to the invention can be either transmission-mode or reflection mode devices. Embodied as a transmission-mode CP, the FSS is preferably the only optically reflective component included. Embodied as a reflection-mode CP, a ground plane is disposed beneath the optically transparent layer. For the reflection-mode CP, the optically transparent layer preferably has a thickness of approximately one-quarter wave at a nominal design wavelength for the CP to function as an isolation layer. The optically transparent layer can comprise amorphous silicon.

The CP can include a support layer beneath the optically transparent layer. The support layer can comprise a semiconductor die. In another inventive embodiment, the support layer can comprise a flexible support material.

The spaced apart electrically conductive spiral shaped features are preferably nanoscale features. The CP can process infrared signals in a wavelength range from 3 and 15 μm. The spiral shaped features are preferably formed from transition metals, such as Mn, Ni, Cr, Cu or V. The CP can include a superstrate layer disposed on the FSS.

### BRIEF DESCRIPTION OF THE DRAWINGS

There are shown in the drawings embodiments which are presently preferred, it being understood, however, that the invention can be embodied in other forms without departing from the spirit or essential attributes thereof.

FIGS. 1A-D schematically show structures of conventional circular polarizers.

FIG. 2 shows a portion of a CP including a frequency selective surface (FSS) according to the invention comprising spaced apart metal spirals shown as gray lines disposed on an insulating substrate that appears dark in this scanning electron micrograph (SEM).

FIG. 3(a)-(c) show exemplary spiral shaped feature embodiments.

FIG. 4 shows a cross-section of the FSS strata from a reflection-mode CP according to the invention and its RLC circuit analog, as well as its quarter-wave transmission line to a metallic ground plane. This analogy shows how the FSS-based CP functions as a resonant wave device, responding to a particular bandwidth of IR radiation.

### DETAILED DESCRIPTION

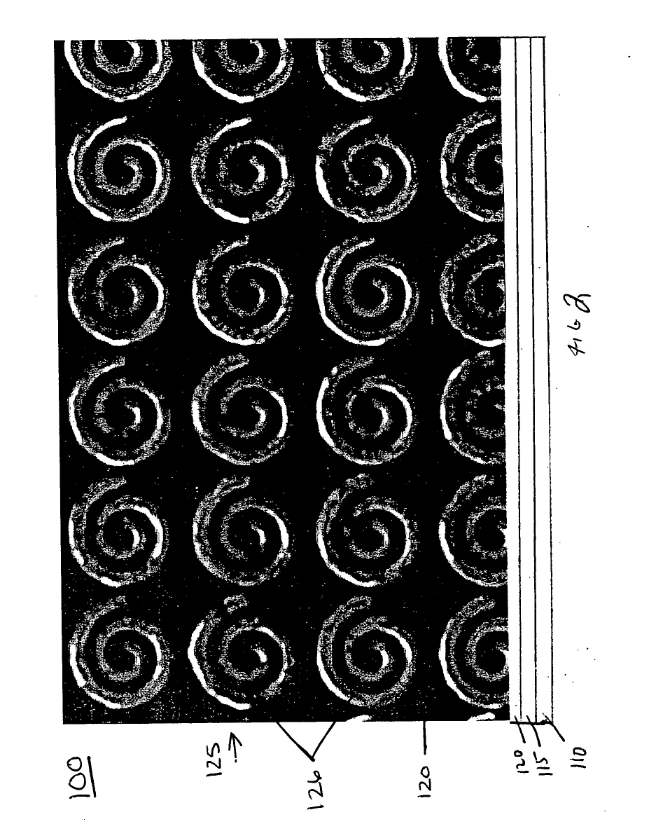

A reflection mode circular polarizer 100 according to an embodiment of the invention is shown in FIG. 2. The circular polarizer (CP) 100 is a passive, essentially planar device which includes a support 110 and a metallic ground plane 115 disposed on the support 110. An electrically insulating or semiconducting and optically transparent layer 120 is disposed on the ground plane 115. A frequency selective surface (FSS) 125 comprising a periodic array of spaced apart electrically conductive spiral shaped features 126 is disposed on layer 120. Although generally desirable herein for reflective applications, for transmission-mode applications, CP 100 can be a transmission-mode CP by embodying circular polarizer 100 without metallic ground plane 115.

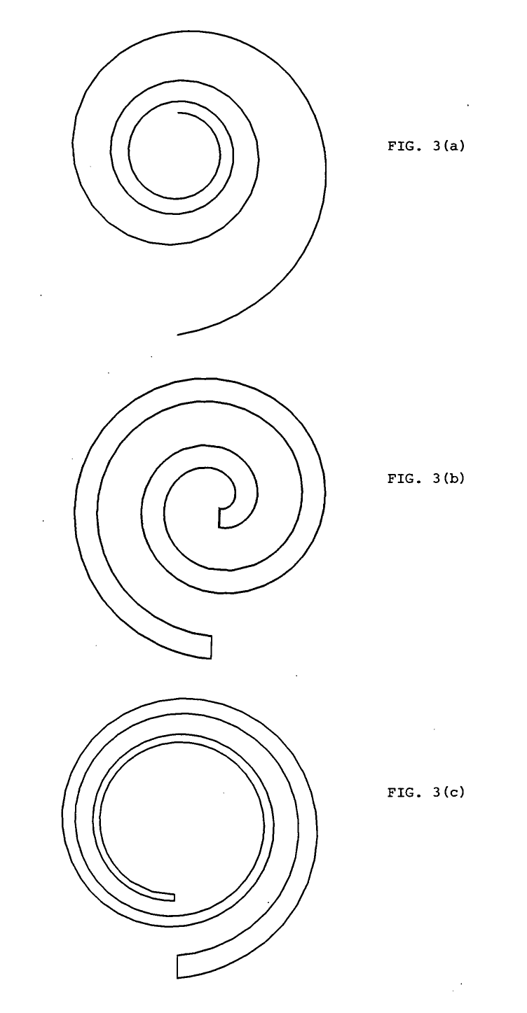

As used herein, the phrase “spiral shaped features” is defined to include electrically conductive traces such as spiral features 126 shown in FIG. 2, being wire-loop traces where the outer perimeter of the spiral is electrically conductive (e.g. metal) and the inner region is optically clear to the underlying layer, or apertures in an electrically conductive sheet, each spiral feature providing at least a portion of the length thereof having continuous curvature. The spiral features can be linear or wire logarithmic spirals shown in FIG. 3(a), closed loop linear spirals shown in FIG. 3(b), or closed loop logarithmic spirals shown in FIG. 3(c). The entire length of the spiral feature or apertures preferably provides continuous curvature, such as spiral features 126 shown in FIG. 2, and FIGS. 3(a)-(c).

Although referred to as a circular polarizer, circular polarizer 100 is more generally an elliptical polarizer. Though its maximum extinction effect as a polarizing optic takes effect when acting upon circularly polarized radiation, circular. polarizers according to the invention will process elliptically polarized radiation to a lesser degree.

The desired frequency of operation determines the element dimensions, spacing and thickness of the FSS spiral elements, as well as the element and substrate materials. The infrared properties of the materials are important to device operation in that the substrate should be highly transparent and non-lossy across the band of operation, and the FSS elements should be optically absorbent at the desired frequency of operation. Thicker FSS elements provide improved attenuation (and thus a higher extinction coefficient), and are thus generally preferred, but are generally limited by properties of available lithographic fabrication processes. As described below, given a desired frequency of operation and polarization response, modeling code can be used to determine suitable element dimensions and materials.

The minimum area of the FSS-based CP depends on the intended application. For example, for laser applications, the FSS-based CP area must be at least as large as the laser beam passing through the FSS-based CP. Applied to cameras, the FSS-based CP can be small if applied direction to the image plane (pixels), or large if incorporated in the optical lens system of the camera.

Although a single FSS-based CP 125 is shown in FIG. 2, a composite device may contain multiple, cascaded FSS layers which can each provide polarization filtering for a different spectral band. Such a composite device can provide multiple-band (wavelength) operation. As noted below, CPs according to the invention can be combined with spectral filters, such as in a forward looking infrared (FLIR) spectral/polarizing camera.

Through use of submicron (nanoscale) FSS features 126, circular polarizer 100 can process infrared radiation from 3 μm<λ<40 μm. Using micron scale features circular polarizer 100 can process far infrared signals including terahertz and millimeter wave radiation. Using advanced lithographic equipment to obtain far nanoscale dimensions, circular polarizers 100 according to the invention can extend to the near infrared 0.70 μm <λ<3 μm, and likely even the visible spectrum when enabling technologies become available for features sizes less than about 10 nm.

The support 110 can comprise a wide variety of materials which provide mechanical strength to circular polarizer 100, such as semiconductor (e.g. Si wafer) substrates. In reflection mode operation, the ground plane 115 generally allows a wide variety of substrate supports 110 to be used without measurably affecting the performance of circular polarizer 100. When wafer substrates are used, circular polarizers according to the invention can be fabricated on the same chip as electronic, optical or MEMS components using conventional integrated circuit processing techniques.

As noted above, reflective mode operation of FSS-based CP, according to the invention, preferably includes a ground plane 115. In this embodiment, the metallic ground plane 115 renders the support 110, such as a base Si wafer, electrically and optically of little or no significance because radiation will not measurably pass this optically thick ground plane 115. Ground plane 115 thus can be viewed as both an electrical ground plane and as a reflector that will reradiate incident infrared radiation.

As noted above, by eliminating ground plane 115 and placing the FSS-based CP on an electrically insulating or semiconducting and optically transparent material 120, FSS-based CPs, according to the invention can operate in transmission mode. Without ground plane 115, the resonant cavity bounded by ground plane 115 and FSS 125 of CP 100 shown in FIG. 2 is no longer provided.

While thin support layers are helpful to mitigate losses, thin supports are not generally required for most applications if a low-absorption, high-transmission materials are used for support 110. Low- absorption, high-transmission materials include, but are not limited to, zinc selenide, high-resistivity silicon, calcium flouride, gallium arsenide, germanium, and thallium bromoiodide (for high bandwidth application). If support 110 is a silicon substrate, for example, support 110 is substantially optically transparent in the wavelength range of about 3 to 9 μm.

However, in some applications it may be desirable to thin the support to improve light transmission therethrough. In one embodiment, support comprises the semiconductor membrane provided by insulator (SOI) substrates, where backside etching is used to remove the insulator layer in the active area of the device. The FSS-based CP preferably utilizes the thin semiconductor membrane.

Spiral shaped features 126 are formed from an electrically conductive material which is generally a metal. It may also be possible to form spiral shaped features 126 from degeneratively doped semiconductors (n+or p+). A typical thickness for spiral features 126 is 30 to 300 nm, but thicker layers may be helpful to CP operation, if possible based on capabilities of the process available processing. Since thin film resistivity scales indirectly with film thickness, a high resistivity metal is generally desired so that the FSS 125 may be as thick and uniform as possible, such that uniform metallic grains are allowed to grow during the metal deposition. Lossy metals assist in shaping the FSS absorption spectrum and are thus generally preferred. Lossy metals include manganese (Mn), and other transition metals, such as Ni, Cr, Cu, and V. Mn is generally preferably based on its relatively high resistance among transition metals.

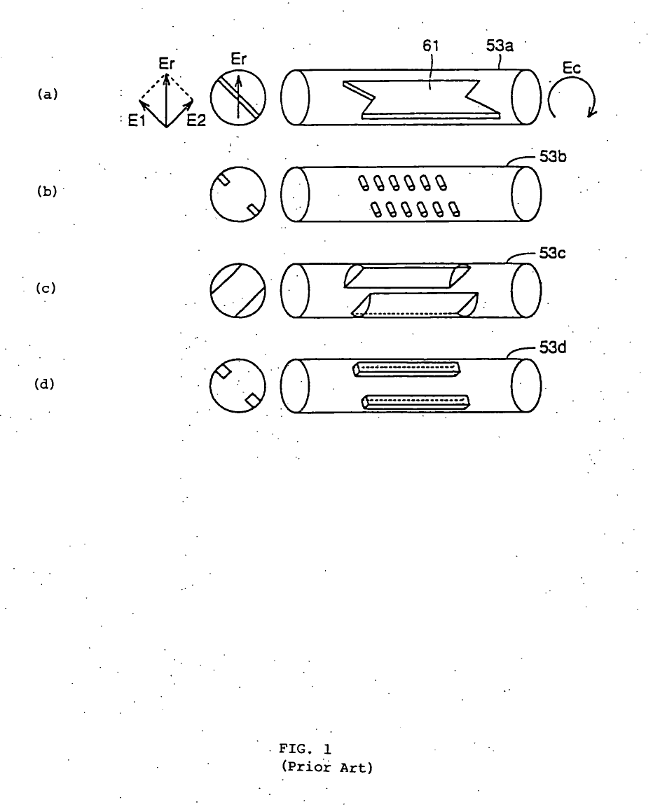

As noted above, circular polarizers according to the invention can operate in the infrared spectral region. As noted in the background, in conventional CP designs, such as shown in FIGS. 1A-D, the devices are designed for millimeter wave operation. These devices are generally fabricated using via photo etching of conducting sheets, vapor deposition onto photoresist, or laser milling.

For FSS operation as a circular polarizer at short wavelengths such as infrared radiation, fine geometry features are required, such as submicron line widths. One method for forming the required fine features is using electron beam lithography (EBL). Although EBL is preferred, other methods for forming fine features may be used with the invention.

Designs according to the invention can be performed using the Periodic Method of Moments (PMM) code or other modeling techniques to model FSS. The Periodic Method of Moments (PMM) method (L.W. Henderson, “Introduction to PMM, Version 4.0,” The Ohio State university, Electroscience Lab., Columbus, Ohio, Tech. rep. 725 347-1, Contract SC-SP18-91-0001, July 1993) is preferably used. This code has been used for millimeter wave FSS designs, and is capable of designing FSS to operate at the higher frequencies of the infrared. The PMM output plots the reflection and transmission spectra for the electric field and the power spectra of radiation reflected and transmitted by a FSS. The element dimension, distribution, and electrical properties of all media comprising the circular polarizer are input to the PMM modeling code. Broadband optical properties of the component materials are preferably integrated into PMM-based design software. The PMM code design process is generally iterative in nature.

FSS designs according to the invention can be represented and modeled using a circuit analog based on the FSS 125 together with optically transparent and electrically insulating or semiconducting layer 120. In the case of reflection-mode CPs, optically transparent and electrically insulating or semiconducting layer 120 is preferably configured to function as an isolation layer and is hereafter referred to as isolation layer 120. An exemplary circuit analog representation will be described relative to a reflection-mode FSS-based CP according to the invention. As noted above, in reflection-based designs, a ground plane 115 is generally preferably included. Isolation layer 120 embodied as an amorphous silicon layer is included to provide isolation from ground plane 115. Other isolation layers materials may be used with the invention. Preferred material for isolation layer 120 are materials which are spectrally flat and highly optically transparent in the wavelength range of interest. For IR applications, a variety of II-VI materials which are known to be useful as IR lens materials, such as zinc selenide (ZnSe), zinc sulfide (ZnS), and cadmium selenide (CdSe), can be used for isolation layer 120.

For reflection FSS-based CP operation, the isolation layer 120 is preferably tuned such that the thickness of this layer is approximately one-quarter wave at the design wavelength. In circuit-analog theory, layer 120 can thus be considered a quarter-wave impedance transformer. Thus, amorphous silicon isolation layer 120 acts as an optical resonant cavity to enhance the performance of the metallic spiral FSS-based CP.

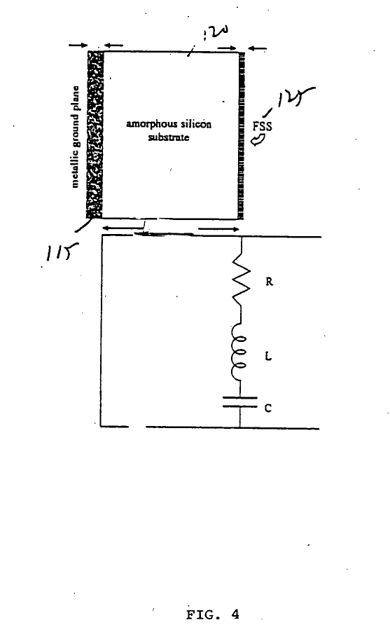

As note above, for reflection mode CPs according to the invention, metallic ground plane 115 is provided which acts as an optical reflector as it does not allow any significant radiation to pass through. FIG. 4 shows the circuit analog of the reflection-mode CP shown in FIG. 2. The circuit analog can be explained on the basis of its RLC equivalents. The metal spirals 126 give to inductance to the FSS 125 as incident radiation excites current in these spirals 126. Both the sub-micron gaps between the metallic spirals 126 and sub-micron gaps between the wires comprising the spirals are capacitors having a dielectric (air) gap between the respective wires. An equivalent resistance is present because the FSS comprises metallic elements which are lossy. Thus, the FSS can be modeled as the analog RLC circuit network, shown in FIG. 4.

The FSS element 126 structure and material as well as the insulation layer 120 material should be selected with care as they can significant impact the performance of circular polarizers according to the invention. The electrical characteristics of the FSS elements 126 and surrounding isolation layer 120 have the effect of shaping and stabilizing the spectral curves with respect to incidence (or emission) angle, as well as the polarization state of the incident radiation. For instance, the presence of insulation layer 120 detunes the FSS resonance. However, lengths of spirals 126 can be adjusted to compensate for this effect. The effective element size is scaled by the electro-optical properties (dielectric permittivity) of the surrounding support (and/or optional superstrate above) media. In general, a higher permittivity material disposed in contact with the spiral features resonate at wavelengths that are shorter than the wavelengths at which they would resonate in free space.

The invention can be embodied in various arrangements. In one arrangement, the spectral signature of the circular polarizer can be altered using an optically transparent superstrate disposed thereon. The superstrate layer can shape the broadband FSS spectral response and decreases sensitivity of the spectral response to operational angle. Furthermore, successful application of a superstrate layer can allow for the addition of cascaded FSS layers, which also has the effect of contouring the spectral signature, for broadband operation, for instance. A superstrate layer permits fabrication of devices where FSS element arrays are sandwiched between two optically transparent transmissive materials. Furthermore, the incorporation of the superstrate layer can help to protect the FSS elements from damage in applications.

In another alternate embodiment, the FSS is fabricated on a flexible substrate, such as KAPTON™, rather than on a rigid silicon wafer 110, so that the FSS can be contoured to the surface on which it is applied. A flexible substrate allows devices to be incorporated onto a curved surface in application, when necessary. In this embodiment, the layers of the composite FSS-based CP device are preferably conditioned to avoid material failure (cracking, delamination) with flexure.

The invention is expected to have a wide variety of applications. For example, the invention can be used to provide improved forward looking infrared (FLIR) spectral/polarizing cameras and related systems. Conventional infrared cameras are based on solely on thermal imaging. FLIR imaging cameras are used for military, night vision, industrial, R & D, maintenance, condition monitoring, medical, security, law enforcement & surveillance applications.

A conventional FLIR camera is configured similar to a standard digital camera. A standard digital camera includes in serial combination optics (including a lens), a CCD array, where the lens focuses the image on the CCD array, and A/D converter and memory. The cells in the CCD array each produce a voltage based on the light intensity hitting the cell. The A/D converter converts each voltage to a scaled value, such as 0 to 255. The scaled integer values are then passed to the memory, where each sensor in the CCD has a specific location that is duplicated in the memory.

Unlike the digital camera, the optics of a FLIR camera are transmissive to IR radiation and its sensors are sensitive to IR radiation, rather than to visible radiation. Transmission-based IR FSS-based CP according to the invention can be integrated onto or over a portion of or the entire detector array (focal plane array) of cameras including FLIR cameras, or other thermal imagers for IR application. Such an arrangement provides a conventional IR imager with polarization-sensitive imaging capability. Thus, unlike conventional FLIR cameras which can only detect spectral changes, FLIR cameras according to the invention can detect both spectral and polarization changes.

Through the ability to detect polarization changes allows for polarimetric imaging, which is the ability to distinguish different polarization in a scene. The ability to detect both spectral and polarization information using FLIR cameras according to the invention is expected to provide enhanced detection sensitivity. Enhanced detection sensitivity can improve combat readiness and other military related applications, including night vision and surveillance.

### EXAMPLES

The present invention is further illustrated by the following specific Examples, which should not be construed as limiting the scope or content of the invention in any way.

A spiral FSS 125 was written on a stratified isolation layer 120 with a Leica EBPG 5000+ electron-beam lithography (EBL) system. Underlying the base of the isolation layer 120 was a silicon wafer 110 of 375 μm thickness for mechanical stability during fabrication and testing. A 150 nm thick gold ground plane 115 was thermally evaporated onto the bare, clean silicon wafer 110 using a BOC Edwards evaporation system. An amorphous silicon isolation layer 120 having a thickness of about 150 nm was then deposited via radio frequency diode sputtering using a MRC 8667 sputtering system. The thickness of this isolation layer 120 is important to the performance of the FSS and thus the circular polarizer, as will be discussed below.

The amorphous silicon isolation layer was then prepared for EBL by spin-coating a single-layer resist of 300 nm of 950 k poly(methyl methacrylate) (PMMA). Spiral structures 126 were written in this resist at a calibrated dose of 500 μC/cm². The fine loop line width of about 200 nm is shown in FIG. 2, which as noted above is a scanned SEM showing a portion of a FSS 125. This feature size is well within the resolution of the EBL system, producing a uniform pattern across the field. To fill the minimum sample field requirement of the optical characterization systems, the FSS-based CP must generally extend over a three millimeter square. This was accomplished by stitching write fields using the Leica pattern generation and stage control software.

After exposure in the EBL system, the FSS was developed in a 25% solution of methyl isobutyl ketone in isopropanol (3:1::IPA:MIBK). The device was then taken through a descum process in oxygen plasma to ensure clarity of the written features. Manganese metal to form the FSS elements 125 were deposited via thermal evaporation. Features were lifted off in a methylene chloride bath with ultrasonic agitation. The FSS 125 was cleaned with solvents and dried with dry nitrogen before spectral characterization.

The FSS formed 125 thus comprised a 150 nm gold ground plane 115, an amorphous silicon isolation layer 120 and a thin, patterned surface of metallic spirals 126. The silicon wafer 110 was used only as a rigid, stable structure. Ground plane 115 comprising 150 nm of gold was deposited on base wafer 110. As noted above, ground plane 115 is not required for transmission-mode FSS-based CP designs according to the invention.

Amorphous silicon isolation layer 120 is included as isolation from this ground plane 115. The amorphous silicon isolation layer 120 was tuned such that the thickness of this layer is approximately one-quarter wave at the exemplary design wavelength of resonance at 6.5 μm. That is:
(1) d (quarter wave)=λ/4n

where n=3.42, the refractive index of the amorphous silicon isolation layer. Thus, the thickness of isolation layer 120 should be 475 nm to be one-quarter wave. Accordingly, isolation layer 120 acts as an optical resonant cavity to enhance the performance of the metallic spiral FSS-based circular polarizer.

This invention can be embodied in other forms without departing from the spirit or essential attributes thereof and, accordingly, reference should be had to the following claims rather than the foregoing specification as indicating the scope of the invention.

We claim:

1. A circular polarizer (CP), comprising:
an optically transparent and electrically insulating or semiconducting layer, and
a frequency selective surface (FSS) disposed on said optically transparent layer, said FSS comprising a periodic array of spaced apart electrically conductive spiral shaped features.

2. The circular polarizer of claim 17 wherein said FSS is the only optically reflective component included with said CP, wherein said circular polarizer is a transmission-mode CP.

3. The circular polarizer of claim 1, further comprising a ground plane disposed beneath said optically transparent layer, wherein said circular polarizer is a reflection-mode circular polarizer.

4. The circular polarizer of claim 3, wherein said optically transparent layer has a thickness of approximately one-quarter wave at a nominal design wavelength for said CP.

5. The circular polarizer of claim 1, wherein said optically transparent layer comprises amorphous silicon.

6. The circular polarizer of claim 1, further comprising a support layer beneath said optically transparent layer.

7. The circular polarizer of claim 6, wherein said support layer comprises a semiconductor die.

8. The circular polarizer of claim 6, wherein said support layer comprises a flexible material.

9. The circular polarizer of claim 1, wherein said spaced apart electrically conductive spiral shaped features are nanoscale features.

10. The circular polarizer of claim 1, wherein said spaced apart electrically conductive spiral shaped features comprise at least one transition metal selected from the group consisting of Mn, Ni, Cr, Cu and V.

11. The circular polarizer of claim 10, wherein said transition metal is Mn.

12. The circular polarizer of claim 9, wherein said circular polarizer processes infrared signals in range between 3 and 15 μm.

13. The circular polarizer of claim 1, further comprising a superstrate layer disposed on said FSS.
